(19) United States
(12) Patent Application Publication
(10) Pub. No.: US 2008/0068127 A1
(43) Pub. Date: Mar. 20, 2008

(54) System and method thereof of a remotely controllable home network system for domestic appliances

(76) Inventors: Cheng-Ru Lin, Taipei City (TW); David Caldecott Yule, Taipei City (TW); Jeng-Chun Chen, Taipei City (TW); Cheng-Yue Chang, Gongguan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/513,074

(22) Filed: Aug. 31, 2006

(51) Int. Cl. G05B 23/02

(52) U.S. Cl. 340/3.7; 340/825.52; 340/825.22

(57) ABSTRACT

The present invention relates to a system and a method thereof of a remotely controllable home network system for domestic appliances. A first processing unit, a first memory unit, a first display unit, and a first network unit are installed in a first domestic appliance of a domestic network system. In addition, the first memory unit is used to store action status information of the first domestic appliance. Thereby, a second domestic appliance that proposes an action request can complete the action of the first domestic appliance in succession after the second domestic appliance selects an execution item via a second display unit. Accordingly, the application convenience is enhanced.

### FIELD OF THE INVENTION

The present invention relates generally to a home network system for domestic appliances, and more particularly to a system and a method thereof of a remotely controllable home network system for domestic appliances.

### BACKGROUND OF THE INVENTION

At present time of rapid network development, there have been more and more applications extending into homes. On the other hand, with the prevalence of broadband network, network equipments and digital information products are presented to the market in succession. In addition to promoting many innovative services of network applications, in the meantime, it also accelerate the development of digital homes, which further realizes the dream of home intelligence. Although there is no common consensus on the definition of home intelligence in the industry, most efforts are generally put on how to integrate these networked domestic appliances in order to achieve the purpose of automation, network, and intelligence to provide people a more comfortable, more convenient and securer living environment.

Generally speaking, there exists tens of domestic appliances or information equipments in modern homes. This means that there will be many intelligent domestic appliances and information products with various purposes in future homes. A common network platform is needed to integrate these varied equipments. Currently, intelligent home network system for domestic appliances is a combination of Internet, communication technologies, and domestic appliances. Although most present networked domestic appliances form a LAN (Local Area Network) by means of a network system, it is not possible to complete the same execution action successively via different domestic appliances with the same functions owing to lack of a synchronous mechanism on each domestic appliance of the home network.

Consequently, according to the problem described above, a proposed novel system and a method thereof of remotely controllable home network systems for domestic appliances not only can improve the disadvantage of disability of completing an action successively via different domestic appliances with the same functions, but also can achieve the succession function at any time and from any said domestic appliances. Thereby, the problem described above can be solved.

### SUMMARY

The purpose of the present invention is to provide a system and a method thereof of a remotely controllable home network system for domestic appliances, which makes a first domestic appliance be able to control a second domestic appliance through a home network for domestic appliances, or makes the second domestic appliance control the first domestic appliance. In addition, different domestic appliances can complete respective actions successively at any time, enhancing application convenience.

The other purpose of the present invention is to provide a system and a method thereof of a remotely controllable home network system for domestic appliances. When there are other services in one of the domestic appliances, a signal will be transmitted to inform the first domestic appliance such that users can know the services in other domestic appliances via the first domestic appliance, enhancing application convenience.

In order to achieve the purpose and the advantage described above, the present invention makes use of installing a second processing unit, a second memory unit, a second display unit, and a second network unit in a second domestic appliance of a domestic network system. The second display unit is made to be the communication bridge with users. In addition, the second memory unit is used to store action status information of the second domestic appliance. When a user logins to the first domestic appliance of the home network for domestic appliances, and when the first domestic appliance transmits an action request message, each of the domestic appliances will return the action status information back to the first domestic appliance. By means of the items selected by the user, the first domestic appliance will continue the action of the second domestic appliance according to the items selected by the user such that the succession function is achieved. Furthermore, at the same time when the user uses the first domestic appliance, if there are other services in one of the domestic appliances in the home network for domestic appliances, a signal will be transmitted to the user, enhancing application convenience.

### BRIEF DESCRIPTION OF THE DRAWINGS

FIG. 1 is a systematical block diagram of a remotely controllable home network system for domestic appliances according to a preferred embodiment of the present invention;

FIG. 2 is a method flowchart of a remotely controllable home network system for domestic appliances according to a preferred embodiment of the present invention;

FIG. 3 is another method flowchart of a remotely controllable home network system for domestic appliances according to a preferred embodiment of the present invention; and

FIG. 4 is another systematical block diagram of a remotely controllable home network system for domestic appliances according to a preferred embodiment of the present invention.

### DETAILED DESCRIPTION

In order to make the system and characteristics as well as the effectiveness of the present invention to be further understood and recognized, the detailed description of the present invention is provided as follows along with preferred embodiments and accompanying figures.

Owing to lack of a synchronous mechanism in the prior-art home network system for domestic appliances, it is not possible to complete an action successively via different domestic appliances. Thereby, to solve the problem in the prior art, the present invention provides a system and a method thereof of a remotely controllable home network system for domestic appliances.

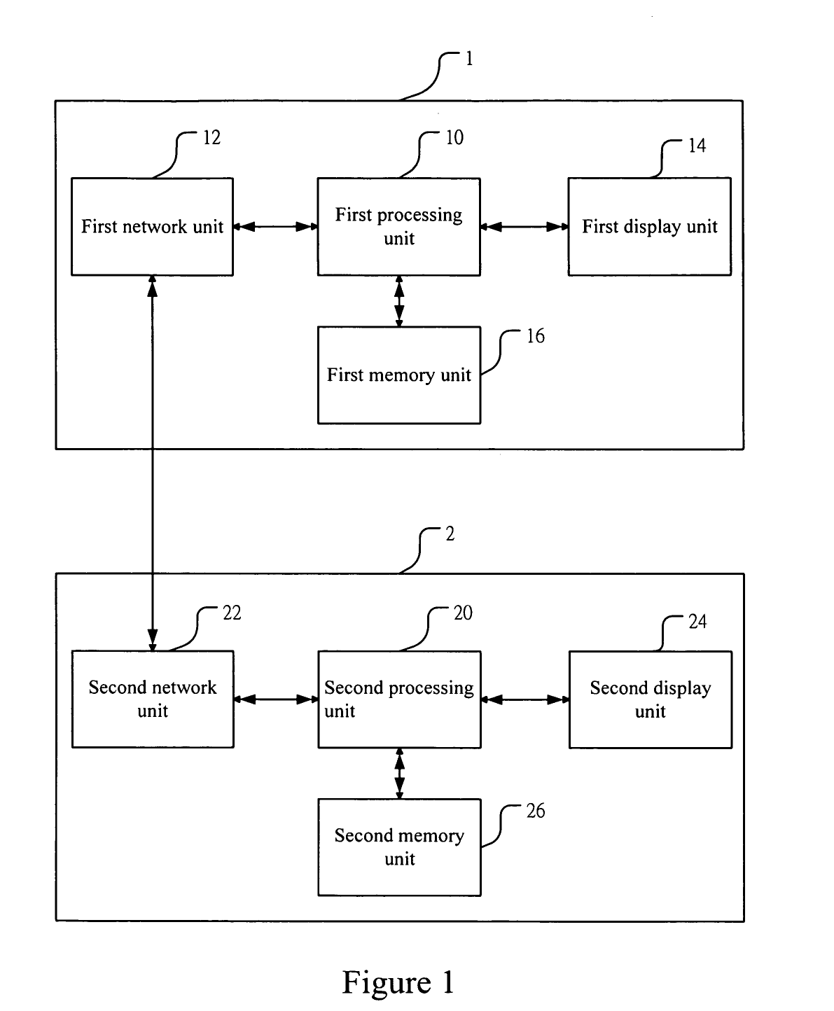

First, please refer to FIG. 1, which is a structural block diagram of a remotely controllable home network system for domestic appliances according to a preferred embodiment of the present invention. The system of a remotely controllable home network system for domestic appliances according to the present invention comprises at least a first domestic appliance 1 and a second domestic appliance 2, wherein the first domestic appliance 1 comprises a first processing unit 10, a first network unit 12, a first display unit 14, and a first memory unit 16, and the second domestic appliance 2 comprises a second processing unit 20, a second network unit 22, a second display unit 24, and a second memory unit 26. The first domestic appliance 1 and the second domestic appliance 2 are connected to be a home network for domestic appliances by means of the second network unit 22 and the first network unit 12. The first domestic appliance 1 and the second domestic appliance 2 can be multimedia devices, wherein the first memory unit used for storing action status information of the first domestic appliance and the second memory unit used for storing action status information of the first domestic appliance, and make use of fact that each of the display units is a touch panel screen, and thereby can be used as the input and output device for users. When a user logins to the first domestic appliance 1, the first network unit 12 of the first domestic appliance 1 will broadcast an action request to the second network unit 22 of the second domestic appliance 2. After the second network unit 22 of the second domestic appliance 2 receives the action request, the second domestic appliance 2 will inform the second processing unit 20 to read action status information from the second memory unit 26, and then return the action status information back to the first domestic appliance 1 via the second network unit 22. After the first domestic appliance 1 receives the action status information of the second domestic appliance 2, the first domestic appliance 1 will filter the action status information by means of the first processing unit 10 of the first domestic appliance 1 to eliminate the action status information that can not continue actions or the actions unable to operate domestic appliances. In addition, by means of selecting to control the second domestic appliance successively by the user, the filtered list of the action status will be displayed on the first display unit 14, from which the user can choose one of the execution items. When the user selects the execution item, the first processing unit 10 of the first domestic appliance 1 will extract the action information in the second domestic appliance 2 whose actions are expected to be succeeded such that the actions of the second domestic appliance 2 will be continued in succession.

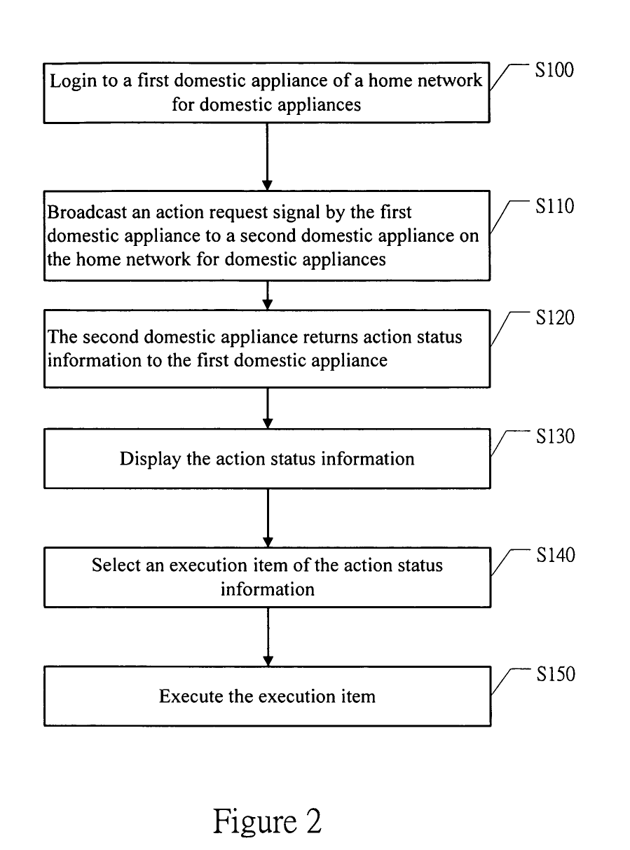

Furthermore, please refer to FIG. 2, which is a method flowchart of a remotely controllable home network system for domestic appliances according to a preferred embodiment of the present invention.

In the step S100, login to a first domestic appliance of a home network for domestic appliances: A touch panel screen is used as the communication bridge between a user and the first domestic appliance.

In the step S110, broadcast an action request message by the first domestic appliance to a second domestic appliance on the home network for domestic appliances: As soon as the user logins to the first domestic appliance, the first domestic appliance broadcasts immediately the action request message to the second domestic appliance connected to the home network for domestic appliances, wherein the action request message is transmitted to the second domestic appliance via UDP/IP packets, and wherein the content of the action request message comprises names of action instructions, usernames, or the location of the first domestic appliance.

In the step S120, the second domestic appliance returns action status information to the first domestic appliance: After the second domestic appliances receives the action request message broadcast by the first domestic appliance, the second domestic appliance will return its action status information back to the first domestic appliance, wherein the action status information comprises the usernames, the action status at that time, or the location of the second domestic appliance. The first domestic appliance will summarize the action status information to an action status list, which includes names of the actions, action status, or the location of the second domestic appliance.

In the step S130, display the action status information: After the user selects to continue the actions of the second domestic appliance, the action status information of the second domestic appliance will be displayed on the first domestic appliance.

In the step S140, select an execution item of the action status information: By means of the action status information displayed on the touch panel screen, the user selects an execution item of the action status information of the second domestic appliance.

In the step S150, execute the execution item: After the user selects the execution item, the action information will be extracted from the second domestic appliance, whose execution is to be succeeded, and the actions of the second domestic appliance will be continued from the first domestic appliance. If the actions of the second domestic appliance are on-going, the first domestic appliance will keep updating the action status of the second domestic appliance, or even can pause or stop the actions of the second domestic appliance and make the actions to be continued in the first domestic appliance.

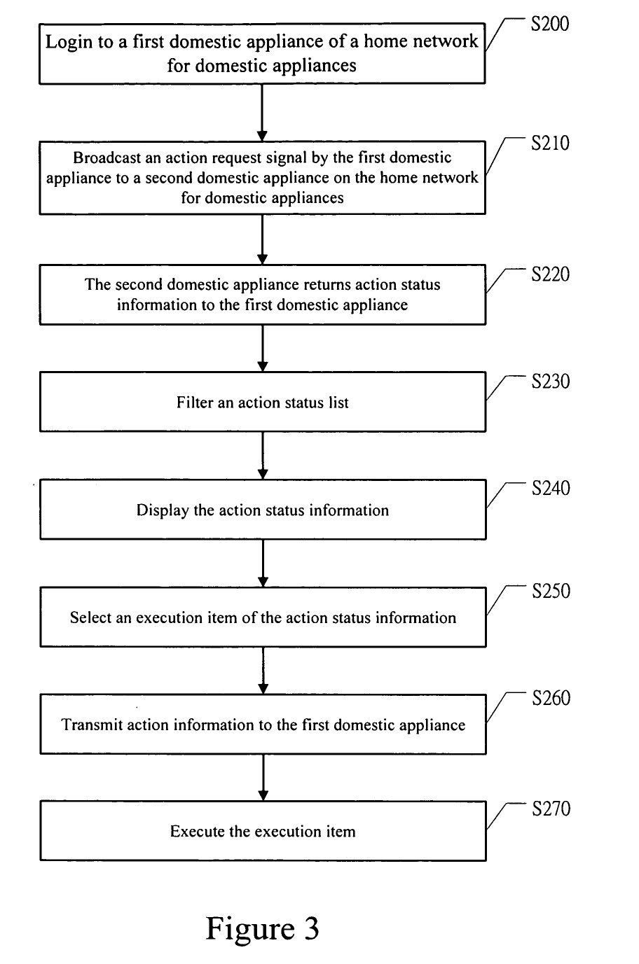

Please refer to FIG. 3, which is another method flowchart of a remotely controllable home network system for domestic appliances according to a preferred embodiment of the present invention.

In the step S200, login to a first domestic appliance of a home network for domestic appliances: A touch panel screen is used as the communication bridge between a user and the first domestic appliance.

In the step S210, broadcast an action request message by the first domestic appliance to a second domestic appliance on the home network for domestic appliances: As soon as the user logins to the first domestic appliance, the first domestic appliance broadcasts immediately the action request message to the second domestic appliance connected to the home network for domestic appliances, wherein the action request message is transmitted to the second domestic appliance via UDP/IP packets, and wherein the content of the action request message comprises names of action instructions, usernames, or the location of the first domestic appliance.

In the step S220, the second domestic appliance returns action status information to the first domestic appliance: After the second domestic appliances receives the action request message broadcast by the first domestic appliance, the second domestic appliance will return its action status information back to the first domestic appliance, wherein the action status information comprises the usernames, the action status at that time, or the location of the second domestic appliance. The first domestic appliance will summarize the action status information to an action status list, which includes names of the actions, action status, or the location of the second domestic appliance.

In the step S230, filter an action status list: By the action status information returned by the second domestic appliance back to the first domestic appliance, the first domestic appliance will list the action status information of the second domestic appliance into the action status list, and filter the actions unable to operate the second domestic appliances from the first domestic appliance.

In the step S240, display the action status information: After the user selects to continue the actions of the second domestic appliance, the action status information of the second domestic appliance will be displayed on the first domestic appliance.

In the step S250, select an execution item of the action status information: By means of the action status information displayed on the touch panel screen, the user selects an execution item of the action status information of the second domestic appliance.

In the step S260, transmit action information to the first domestic appliance: After determining the execution item, the second domestic appliance whose actions are expected to be continued transmits the action information thereof to the first domestic appliance such that the first domestic appliance can continue the actions of the second domestic appliance. If the actions of the second domestic appliance are on-going, the first domestic appliance will keep updating the action status of the second domestic appliance, or even can pause or stop the actions of the second domestic appliance and make the actions to be continued in the first domestic appliance.

In the step S270, execute the execution item: The first domestic appliance continues to execute its actions in succession via the action information transmitted by the second domestic appliance.

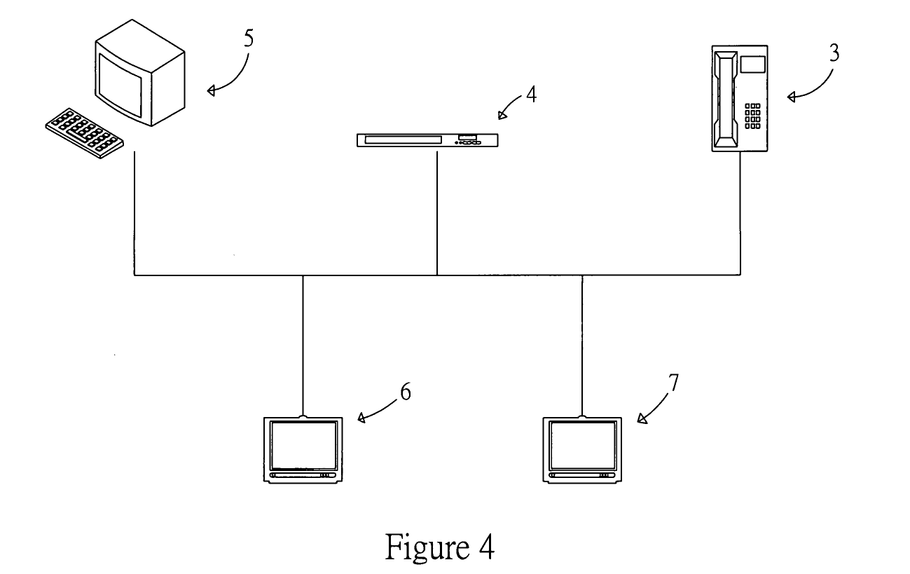

To continue, please refer to FIG. 4, which is another structural block diagram of a remotely controllable home network system for domestic appliances according to a preferred embodiment of the present invention. In the present embodiment, a plurality of domestic appliances are connected to form the home network for domestic appliances. In addition, a Hyper Text Transfer Protocol (HTTP) technology as well as an UPnP-like syntax is adopted. A user views a DVD movie using a living-room television 6 and a DVD player 4. If the user moves to another room and wishes to continue viewing the unfinished DVD movie, at the time when the user turns on a room television 7, the room television 7 will broadcast an action request message to each of the domestic appliances through a home network for domestic appliances, wherein the action request message is as follows:

BROADCAST ⋆ HTTP/1.1
HOST: 239.255.255.250:2345
COMMAND: request-for-action
USERNAME: John
LOCATION: http://10.9.1.123:3931/request-action

After each of the domestic appliances of the home network for domestic appliances receives the action request message, action status information is returned. The room television 7 receives the action status information returned by each of the domestic appliances of the home network for domestic appliances and arranges into an action status list, which is as follows:

POST /request-actions HTTP/1.1
User-Agent: RfA/1.0
Content-Type: x-nearly-xml/action-list
Content-Length: 1223
<todo><id>1</id>
<name>Watch DVD: The Ashes</name>
<summary>DVD Player in living room. You have
watched 23 minutes of a 72 minute long DVD, and last
viewed it 42minutes ago</summary>
<url>http://10.9.1.142:2222/play?id=1</url>
<accept>video/mpeg</accept>
<todo><id>2</id>
...

The room television 7 will filter the action status list to provide the room television 7 with an operable action status list. The user will firstly select the second domestic appliance whose actions are expected to be succeeded, and will then select the first item to continue viewing the DVD movie. The room television 7 extracts DVD movie information and transmits it to the room television 7 for continue viewing the movie by means of the following address:

GET /play?id=1 HTTP/1.1
User-Agent: Rfa/1.0
Host: 10.9.1.142:2222

When the user views the DVD movie, if a telephone 3 receives a short message or a voice message, or if a desktop computer 5 receives a new email, a message will be transmitted via the home network for domestic appliances to inform the user. The user can choose whether to check the short message, new email, or voice message or not.

To sum up, the present invention is a distributed system, forming a home network for domestic appliances by means of each of the domestic appliances in a home. In addition, each memory unit in each of the domestic appliance will store action status information. When a user logins to the first domestic appliance of the home network for domestic appliances, action status information will be returned back to the first domestic appliance. The first domestic appliance arranges the action status information into an action status list for providing the user to select the second domestic appliance whose actions are expected to be continued. Afterwards, the item to be executed is selected such that the actions of the second domestic appliance can be controlled in succession via the first domestic appliance. The purpose thereof is to complete actions on other domestic appliance successively by means of the first domestic appliance of the home network for domestic appliances, enhancing application convenience.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A system of a remotely controllable home network system for domestic appliances, comprising a plurality of domestic appliances, the plurality of domestic appliances comprising
a first domestic appliance, used for storing action status information of the first domestic appliance, used as an input or an output of the first domestic appliance,and used for connecting each of the domestic appliances of the home network for domestic appliances;
a second domestic appliance, used for storing action status information of the first domestic appliance, used as an input or an output,and used for connecting the first domestic appliance and each of the domestic appliances of the home network for domestic appliances;
wherein the first domestic appliance and the second domestic appliance can control each other.

2. The system of claim 1, wherein the first domestic appliance comprising:
a first memory unit, used for storing action status information of the first domestic appliance;
a first display unit, used as an input or an output of the first domestic appliance;
a first network unit, used for connecting each of the domestic appliances of the home network for domestic appliances;
a first processing unit, used for controlling the storage action of the first memory unit and each unit action of the first domestic appliance;
the second domestic appliance comprising:
a second memory unit, used for storing action status information of the first domestic appliance;
a second display unit, used as an input or an output;
a second network unit, used for connecting the second domestic appliance and each of the domestic appliances of the home network for domestic appliances; and
a second processing unit, used for controlling the storage action of the first memory unit and each unit action of the first domestic appliance.

3. The system of claim 1, wherein each of the domestic appliances of the home network for domestic appliances is a multimedia device.

4. The system of claim 2, wherein each of the memory units stores the action status information of each of the domestic appliance every time interval.

5. The system of claim 2, wherein each of the memory units stores the status at the time when the actions of each of the domestic appliance are paused or stopped.

6. The system of claim 2, wherein the display units can be touch panels screens.

7. A method of a remotely controllable home network system for domestic appliances, the method comprising the steps of:
logging into a first domestic appliance of a home network for domestic appliances;
broadcasting an action request signal by the first domestic appliance to a second domestic appliance on the home network for domestic appliances;
returning action status information by the second domestic appliance to the first domestic appliance;
displaying the action status information;
selecting an execution item of the action status information; and
executing the selected execution item.

8. The method of claim 7, wherein before the step of executing the selected execution item, a step of transmitting action information to the first domestic appliance is further included.

9. The method of claim 8, wherein the action information comprises information of actions to be exercised.

10. The method of claim 8, wherein when the actions of the second domestic appliance are on-going, the first domestic appliance will keep updating the action status of the second domestic appliance.

11. The method of claim 10, wherein the first domestic appliance can pause the actions of the second domestic appliance and make the actions to be continued in the first domestic appliance.

12. The method of claim 7, wherein the action request message comprises names of action instructions, usernames, or the location of the first domestic appliance.

13. The method of claim 7, wherein when each of the domestic appliances executes any actions, the action status information will be stored.

14. The method of claim 13, wherein the action status information comprises the usernames, the action status at that time, or the location of the second domestic appliance.

15. The method of claim 7, wherein when a user is using the first domestic appliance of the home network for the domestic appliances, the first domestic appliance will transmit a message to inform the user if there are services to inform the user by the first domestic appliance.

16. The method of claim 7, wherein the selected execution item can be an unfinished action.

17. The method of claim 7, wherein after the step of returning action status information by the second domestic appliance to the first domestic appliance, a step of filtering an action status list is further included.

18. The method of claim 17, wherein the action status list comprises names of the actions, action status, or locations of the domestic appliances other than the first domestic appliance.

19. The method of claim 17, wherein the step of displaying the action status information is changed to the step of displaying a filtered list.

20. The method of claim 18, wherein the step of selecting an execution item of the action status information is changed to the step of selecting an execution item of the filtered list.

21. The method of claim 17, wherein the standard of filtering the action status list is to eliminate actions that the first domestic appliance cannot operate.
